(19) United States
(12) Patent Application Publication
(10) Pub. No.: US 2011/0302655 A1
(43) Pub. Date: Dec. 8, 2011

(54) Anti-virus application and method

(75) Inventors: Antti Tikkanen, Espoo (FI); Mika St+522 hlberg, Espoo (FI)

(73) Assignee: F-Secure Corporation

(21) Appl. No.: 12/802,524

(22) Filed: Jun. 8, 2010

(51) Int. Cl. G06F 21/22

(52) U.S. Cl. 726/24

(57) ABSTRACT

A method of performing an anti-virus scan on an electronic file. An anti-virus application running at a computer device determines that an electronic file requires scanning. The electronic file is placed in a queue for analysis, and the state of the electronic file is altered such that it can be written to a memory but not accessed before analysis is complete. An icon associated with the electronic file is altered to indicate that the analysis is not yet complete, the icon being displayable on a display device. Once the electronic file has been analysed, the icon associated with the electronic file is altered again to indicate that it has been analysed.

### FIELD OF THE INVENTION

The present invention relates to an anti-virus application and a method of implementing an anti-virus application.

### BACKGROUND TO THE INVENTION

Malware infection of computers and computer systems is a growing problem. Recently there have been many high profile examples where computer malware has spread rapidly around the world causing many millions of pounds worth of damage in terms of lost data and lost working time.

Malware is often spread using a computer virus. Early viruses were spread by the copying of infected electronic files onto floppy disks, and the transfer of the electronic file from the disk onto a previously uninfected computer. When the user tries to open the infected electronic file, the malware is triggered and the computer infected. More recently, viruses have been spread via the Internet, for example using e-mail. In the future it can be expected that viruses will be spread by the wireless transmission of data, for example by communications between mobile communication devices using a cellular telephone network.

Various anti-virus applications are available on the market. These tend to work by maintaining a database of signatures or fingerprints for known viruses and malware. With a “real time” scanning application, when a user tries to perform an operation on a file, e.g. open, save, or copy, the request is redirected to the anti-virus application. If the application has no existing record of the electronic file, the electronic file is scanned for known virus or malware signatures. If a virus or malware is identified in a file, the anti-virus application can take appropriate action, such as reporting this to the user, notifying an administrator, disinfecting or blocking the virus of malware. The anti-virus application may then add the identity of the infected file to a register of infected files.

The database for the anti-virus application may be maintained locally at the computer system, or may be located remotely from a client computer system, for example at a server. The server may also be used to perform a determination of whether the electronic file is malware. In this case, a client device that finds a suspicious electronic file sends signature information to the server that helps the server to detect malware files by comparing the signature of the suspicious electronic file with signatures listed in a signature database. Once the server has identified the suspicious electronic file (either as malware or not) it typically reports back to the client.

Whether the anti-virus application is maintained locally at the computer system, or remotely from the computer system, delays can be introduced by the scanning process. When a software application is executed, several executable files are sequentially scanned as the operating system loads them into memory. In the case where the scan operation includes a network lookup, the user-visible performance of the computer may be degraded because the anti-virus application must perform several network lookups in sequence before the software application is running.

Consider the situation where an application is first installed and then used on a computer system; the steps may be as follows:

S1. The user receives an installation executable, installer.exe (or installer.msi etc) from an external source and writes it to the local disk.
S2. Before installer.exe is written to the local disk, the antivirus application scans installer.exe and finds it unknown (not known-clean, not malware).
S3. The file write operation is allowed to complete.
S4. The user executes installer.exe to install the software.
S5. The antivirus application scans installer.exe and finds it unknown (not known-clean, not malware).
S6. Installer.exe writes the following files to the local disk: application.exe, library1.dll and library2.dll.
S7. Before the files are written to the local disk, the antivirus application sequentially scans application.exe, library1.dll and library2.dll and finds each file unknown.
S8. The file writes are allowed to complete.
S9. The user executes application.exe.
S10. The antivirus application scans application.exe and finds it unknown.
S11. Application.exe loads library1.dll and library2.dll.
S12. The antivirus application scans library1.dll and library2.dll sequentially and finds both unknown.
S13. The application is allowed to execute on the computer system.
S14. Each subsequent time that the user launches the application, steps S9 to S13 are repeated.

It is apparent that many network lookups are required to install and execute the application. The scan result is given a time-to-live (TTL), so that:
If the file is known-clean, the TTL is long (of the order of weeks to months)
If the file is known-bad, the TTL is reasonably long (of the order of days to weeks)
If the file is unknown, the TTL is short (of the order of minutes to days).

After the TTL expires, the file enters the not-scanned state and the product needs to rescan the file to refresh its state.

Assuming that all files in the above scenario are unknown, and assuming the user executes application.exe each day, the product would have to perform 3 sequential network lookups each time the application is launched. If the roundtrip time is large enough, this may hurt the usability of the computer. This is not ideal, especially an anti-virus system that uses network lookup.

One way to address this is by separating the write and execute operations so that writing can be allowed before anti-virus analysis is complete, but execution is not. This is achieved by placing lookups in a queue, and performing the lookup when resources are available or when execution of the file is required. When the files are in a queue, they are placed in a “not-scanned” state, and so will not be able to be executed. The separation of the write and execute operations applies not only to the execution of a file, but also scripts and similar files that are not executed by the operating system but interpreted by a related interpreter application. This requires monitoring the interpreter rather than the Operating System to identify when a script of similar file is being interpreted.

If a user attempts to access the file before it has been scanned, the file can be moved to the front of the queue and scanned immediately. Typically, the lookup will have been performed before execution of the file is required. However, the user may not be aware of the current state of scanning of a file. This has several disadvantages: In situations where a communications network connection is not available or is temporarily down, the user may not be aware that the files are not yet ready to be executed yet, and may choose to execute the files anyway. The user would expect to be warned about the scanning status. A typical scenario is where a new application has been installed from a memory device such as a USB stick or a DVD. Furthermore, if the user attempts to execute a file that has not yet been analysed by the anti-virus application, start-up may be slower, to the detriment of the user's experience.

### SUMMARY OF THE INVENTION

According to a first aspect of the invention, there is provided a method of performing an anti-virus scan on an electronic file. An anti-virus application running at a computer device determines that an electronic file requires scanning. The electronic file is placed in a queue for analysis, and the state of the electronic file is altered such that it can be written to a memory but not accessed before analysis is complete. An icon associated with the electronic file is altered to indicate that the electronic file is awaiting analysis, the icon being displayable on a display device. Once the electronic file has been analysed, the icon associated with the electronic file is altered again to indicate that analysis is complete. This ensures that the user of the computer device is aware of the current status of an electronic file and whether or not it has been analysed by looking at the appearance of the icon associated with the electronic file.

Before analysis of the electronic file is complete, the icon associated with the electronic file may be further altered to indicate an altered sub-state within the analysis procedure, such as “queued for analysis”, or “request sent to server”.

As an option, the icon is altered to indicate that the analysis of the electronic file is not yet complete by suppressing display of the icon associated with the electronic file. The user is less likely to attempt to access an electronic file for which analysis is not yet complete if the user cannot see the icon.

As an option, the icon is altered to indicate that the analysis of the electronic file is not complete by setting an attribute of the electronic file to hidden.

In the event that an attempt is made to access the electronic file prior to completion of the analysis, a position of the electronic file in the queue is optionally changed such that the electronic file is analyzed after a current analysis of a further electronic file is complete, and the electronic file is analysed prior to allowing accessing of the electronic file. By moving the electronic file to the front of the queue, analysis is performed before the file is accessed, and the delay for the user in accessing the file is reduced.

Alternatively, in the event that an attempt is made to access the electronic file prior to completion of the analysis, a current analysis operation on a further electronic file is suspended, and the electronic file is analysed prior to allowing accessing of the electronic file. By suspending existing analysis of another file, and analysing the electronic file instead, the file that the user wishes to access is quickly analysed and, if found to be clean, allowed to be access.

In the event that an attempt is made to execute the electronic file prior to completion of the analysis, the user is optionally prompted via the display device to determine whether or not to allow execution of the electronic file.

The anti-virus application may send a network query to a remote anti-virus server during the analysis process. In this case, the anti-virus application optionally sends a single message comprising information relating to a plurality of files to the remote anti-virus server during the analysis process.

In the event that the anti-virus application normally sends a network query to a remote anti-virus server during the analysis process, and a network connection to the remote anti-virus server is unavailable, and the user wishes to execute the electronic file, the user is optionally prompted via the display device to determine whether or not to allow execution of the electronic file.

In the event that the anti-virus application normally sends a network query to a remote anti-virus server during the analysis process, and a network connection to the remote anti-virus server is unavailable, and it is required to execute the electronic file, the user is optionally prompted via the display device to determine whether or not to disable the anti-virus application. This may be until such a time as the user re-enables the anti-virus application or for a predetermined period of time.

Once the electronic file has been analysed, the icon associated with the electronic file is optionally altered to the icon normally associated with the electronic file, an icon indicating that the file has been analysed and does not comprise malware, an icon indicating that the file has been analysed and does comprise malware, or an icon indicating that the file has been analysed and it is not known whether it comprises malware.

Optionally, it is determined that an electronic file requires analysis prior to writing the electronic file to the memory. Alternatively, it is determined that an electronic file requires analysis in the event that a time-to-live setting associated with the electronic file has expired.

Examples of access to the electronic file include any of execution of the electronic file by an operating system, interpretation of the electronic file by an interpreter, attachment of the electronic file to a message, sending the electronic file to a remote node via a communications network, copying the electronic file to an external memory, and displaying information obtained from the electronic file by a data file viewing application.

According to a second aspect of the invention, there is provided a computer device comprising a memory for storing a plurality of electronic files. A processor is provided for running an anti-virus application, wherein the anti-virus application is arranged to determine that an electronic file requires analysis. The processor is further arranged to place the electronic file in a queue for analysis, and allow the electronic file to be written to the memory but not accessed before analysis is complete. Furthermore, the processor is arranged to alter an icon associated with the electronic file to indicate that the analysis of the electronic file is not complete. A display is provided for displaying the icon to a user, and the processor is arranged to submit the electronic file for analysis. Once the electronic file has been analysed, the processor is further arranged to alter the icon associated with the electronic file to indicate that it has been analysed.

As an option, the processor is arranged to, prior to the completion of analysis of the electronic file, further alter the icon associated with the electronic file to indicate an altered sub-state within the analysis procedure.

The processor is optionally arranged to alter the icon by suppressing display of the icon associated with the electronic file or setting a file attribute to “hidden”.

In the event that the anti-virus application normally sends a network query to a remote anti-virus server during the analysis process, and a network connection to the remote anti-virus server is unavailable, and it is required to execute the electronic file, the processor is optionally prompt the user via the display device to determine whether or not to allow execution of the electronic file.

As an option, the processor is arranged determined that an electronic file requires analysis either prior to writing the electronic file to the memory or in the event that a time-to-live setting associated with the electronic file has expired.

According to a third aspect of the invention, there is provided a computer program, comprising computer readable code which, when run on a computer device, causes the computer device to perform the method described in the first aspect of the invention.

According to a fourth aspect of the invention, there is provided a computer program product comprising a computer readable medium and a computer program as described in the third aspect of the invention, wherein the computer program is stored on the computer readable medium.

### BRIEF DESCRIPTION OF THE DRAWINGS

FIG. 1 illustrates schematically in a block diagram a computer device and a server according to an embodiment of the invention;

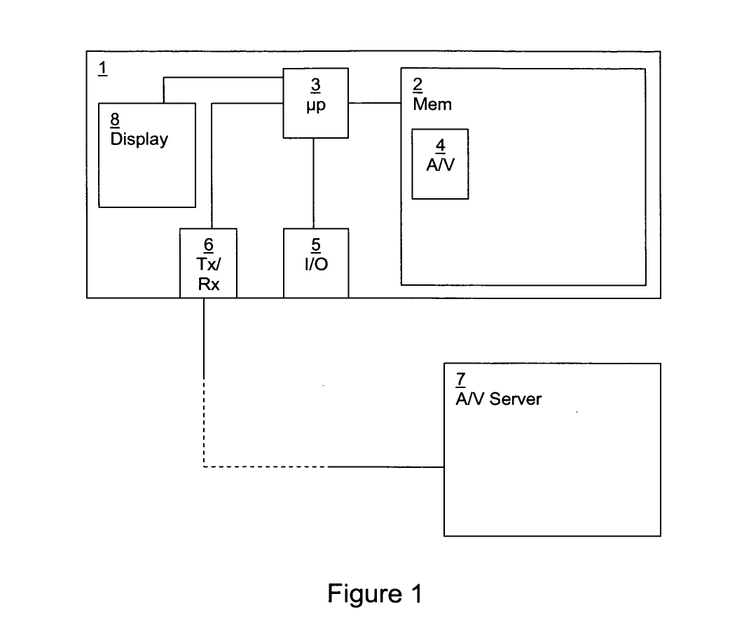

FIG. 2 is a flow diagram illustrating steps according to an embodiment of the invention;

FIG. 3 illustrates a series of exemplary icons according to different embodiments of the invention; and

FIG. 4 is a flow diagram illustrating the steps of an exemplary embodiment of the invention;

### DETAILED DESCRIPTION OF CERTAIN EMBODIMENTS

The present invention makes use of so-called “cloud quarantine”, in which a file is scanned and then placed in a queue for performing lookup at a later time. While the electronic file is in a cloud quarantine state, analysis of the file is not yet complete. A computer system 1 has a computer readable medium in the form of a memory 2 which can be used to store electronic files. The memory may also be used to store computer program which, when executed by a processor 3, runs an anti-virus application 4. An In/Out device 5 (which may be a link to a communication network, a CD-ROM or DVD drive, a floppy disk drive etc.) via which new files can be obtained. A communication device 6 is provided that allows the computer device to communicate with a communications network and contact a remote server 7. Note that the communication device 6 and the In-Out device 5 may be the same physical device. A display 8 is also provided for displaying information to a user of the computer device 8.

The computer device 1 may be any type of computer device, such as a personal computer, a mobile telephone, a laptop and so on.

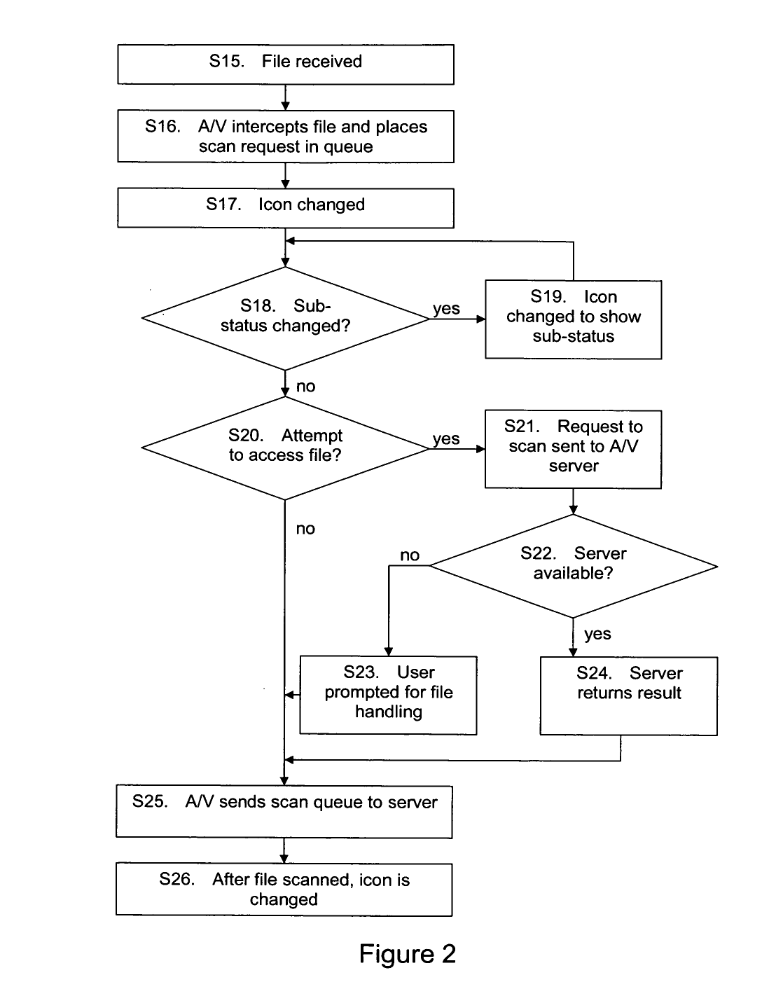

When using cloud quarantine, files may be written to the memory 2 before an anti-virus lookup on them has been completed. During this time they are placed in an “unknown” state and may not be executed. A visual indication is provided to the user as to whether the file is in cloud quarantine or scanned. Referring to FIG. 2, and with the following numbering corresponding to that of FIG. 2:

S15. The computer device receives an electronic file via the In/Out device 5 and attempts to write it to the memory 2.
S16. The anti-virus application 4 intercepts the attempt to write the file to the memory 4, and a scan request for this file is placed in a scan queue. The write operation is allowed to finish.
S17. The way that an icon associated with the file is shown on the display 8 is changed to show a “cloud quarantine” icon (or otherwise indicate that the file is currently in cloud quarantine, showing visually to the user that this file has not yet been analyzed by the cloud. The term “icon” is used herein to refer any visual representation of the file that can be displayed on the display 8.
S18. If the sub-status of the file within the cloud quarantine has changed, the appearance of the icon may change (S19). For example, the icon may illustrate that the file is “queued for analysis”, “request sent” etc. If not, then the method proceeds at step S20.
S19. The appearance of the icon is changed to reflect the sub-status.
S20. If no attempt is made to access the file before the scan queue has been processed, then the method proceeds at step S25. Accessing the file may include any of execution of the electronic file by an operating system, interpretation of the electronic file by an interpreter, attachment of the electronic file to an email message, sending the electronic file to a remote node via a communications network, copying the electronic file to an external memory, and displaying information obtained from the electronic file by a data file viewing application.
S21. As an attempt has been made by the operating system (or another application) to access the file, a request is sent to the A/V server 7 before the scan queue has been processed.
S22. If the A/V server 7 is unavailable, for example because the computer device 1 is not connected to a communications network, or it is determined that a connection has poor bandwidth or latency times are too great, the method proceeds at step S23, otherwise the method proceeds at step S24.
S23. The user is prompted to decide how he wishes to handle the file. For example, the user could be asked whether or not he wishes to access the file even though it hasn't been scanned. This case is particularly useful in a scenario in which the user is off-line and receives a new executable file. The icon associated with the file may be changed to indicate that the file has been accessed but not scanned. Once communication with the A/V Server 7 is restored, the method proceeds at step S25.
S24. The A/V server 7 returns a result of the scan to the computer device.
S25. The anti-virus application 4 sends the scan queue to the anti-virus server to be processed. This may be performed in a batch mode where multiple files are sent in one group in order to reduce signalling. If a file is found to be malicious, an alert is shown to the user.
S26. After the file has been scanned, and the result returned to the computer device, the file is removed from “cloud quarantine” and the icon is changed to an icon that shows the file is known to be clean, or the icon normally associated with the file is restored.

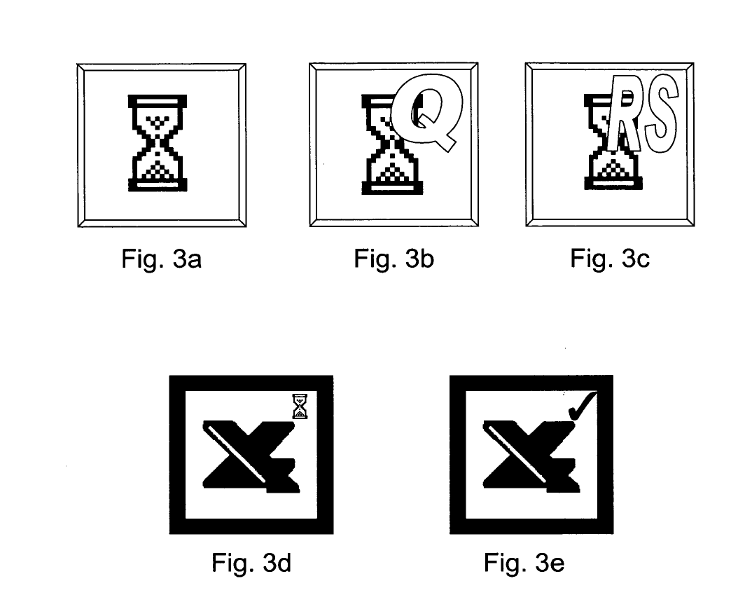

There are several ways in which the way the icon is displayed can be changed to show the current status of a file. FIG. 3a illustrates an icon that may be associated with the file when it is in the cloud quarantine state. FIG. 3b illustrates an icon that may be associated with the file when it is in the cloud quarantine state, and in the “Queued for analysis” sub-state. FIG. 3c illustrates an icon that may be associated with the file when it is in the cloud quarantine state, and in the “Request for analysis sent” sub-state.

These may replace existing icons associated with the file, or may be over-laid over an existing icon associated with the file so that a user can see, for example, that the file is a Microsoft® Excel executable file that is currently in the cloud quarantine state, as illustrated in FIG. 3d. Once the scan has been performed, and the file is known to be clean, the icon can be changed back to the icon normally associated with the file, or may be modified as in FIG. 3e to show that it has been scanned and is free from malware.

Another way to change the way in which the icon is displayed is to display the same icon as is normally used for the application, but “greyed out”. The appearance of the icon is changed or modified on the fly as long as the file is in the cloud quarantine state.

Two possible ways of changing the appearance of the icon are as follows: Firstly, the data used for the representation of the icon may be modified and rewritten, such that whenever it is required to display the icon, the modified data is used. Alternatively, the antivirus application 4 may modify the icon on the fly, which does not involve re-writing the data representing the icon but instead involves changing the user-visible icon by binding the modifications to a part of the display processing. When using a Windows® operating system, this may be done by, for example, using a shell extension library.

As an alternative to changing the appearance of the icon, when a file is in the cloud quarantine state, the icon may be hidden from the user to discourage him from attempting to execute the file associated with the icon while it is in the cloud quarantine. Some operating systems, such as Microsoft® Windows, allow file attributes to be altered. By setting a file attribute to “hidden”, the icon will not be displayed, and the hidden file will not be visible in a normal directory listing. Once the file has been scanned and is known to be clean, the icon can be restored to the icon normally associated with the file.

The user may be given the option, via the anti-virus application 4 interface displayed on the display 8, to disable the “cloud quarantine” feature entirely, or for a specific time period. This may be used if the user is, for example, installing a new application and the communication network is not available. The anti-virus application 4 may include heuristics to detect a valid installation scenario starting, and suggesting this to the user. For example, the anti-virus application 4 may detect that an installer is being run if an application being executed by the user is called “setup.exe”, or has a “.msi” extension. If the computer system 1 does not have access to the communication network, or the connection to the communication network is poor, then the anti-virus application 4 may offer the user the opportunity of disabling the cloud quarantine feature if the user trusts the installers. The disabling feature may be given a “time-out” so, for example, it will be re-enabled after a predetermined period of time.

While the above example describes using the cloud quarantine and changing the icon associated with the file in the context of an anti-virus application that uses a back-end server 7 during scanning, it can equally be applied to other scenarios in which the anti-virus application 4 does not use a back-end server but relies on a local database. This may be useful where, for example, analyzing the file takes longer than average. For instance, if the scanning engine of the anti-virus application 4 is performing a heavy local analysis, the file could be placed in quarantine until this is completed.

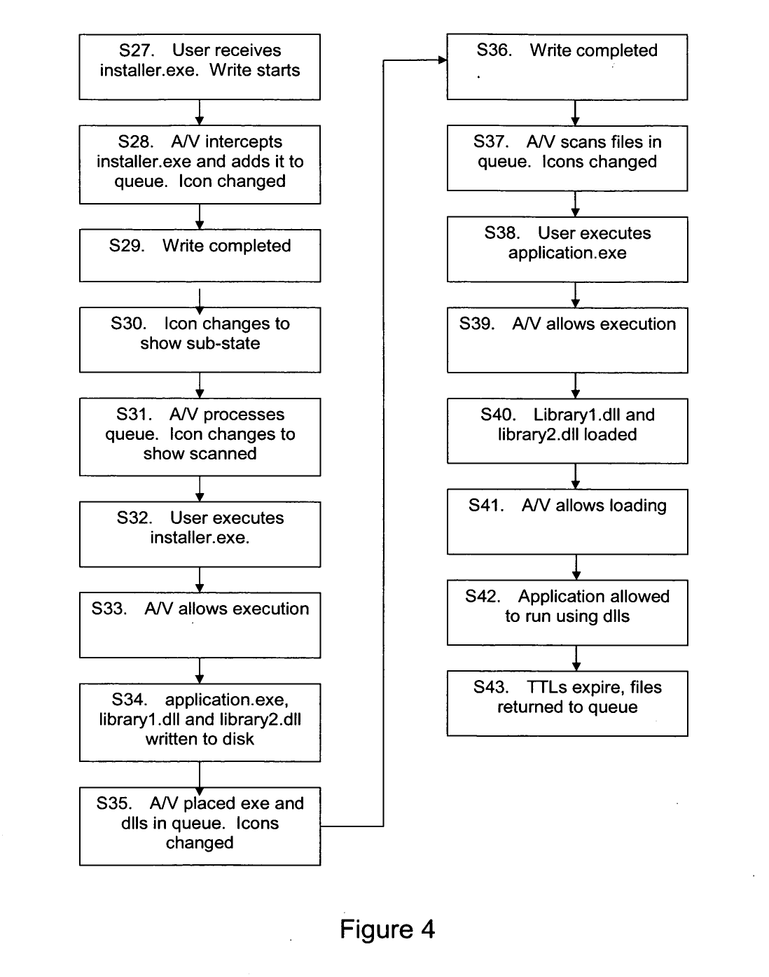

The following example, with reference to FIG. 4, illustrates how the invention may work when a user receives, installs and executes a new software application:

S27. The user receives installer.exe (or installer.msi etc) from an external source via the In/Out device 5 and writes it to the memory 2.
S28. The antivirus application 4 is being run by the processor 3, and receives information about the write operation. The anti-virus application 4 places installer.exe into a background scanning queue and places the file into “cloud quarantine” (the not-scanned state). In addition to that, the anti-virus application modifies an icon associated with installer.exe to show that it has been placed in cloud quarantine. This icon is displayed on the display 8 and shows the user that installer.exe has not yet been analysed.
S29. The file write operation to the memory 2 is allowed to complete.
S30. The icon may change again to indicate sub-states of analysis as the anti-virus application 4 processes the background scanning queue. Examples of sub-states include “queued for analysis”, “request sent” and so on.
S31. The antivirus application 4 processes the background scanning queue, performs a network lookup by contacting and finds installer.exe unknown. The icon for installer.exe changes again to indicate that analysis of installer.exe is complete.
S32. The user executes installer.exe.
S33. The antivirus application 4 is aware that installer.exe is in the unknown state, and the time-to-live (TTL) has not expired, and so execution of installer.exe is allowed.
S34. Installer.exe writes the following files to the local disk: application.exe, library1.dll and library2.dll
S35. The antivirus application 4 places application.exe, library1.dll and library2.dll into background scanning queue and places them into “cloud quarantine” (not-scanned state). Icons for each of the files are changed to reflect that they are in cloud quarantine.
S36. The anti-virus application 4 allows the writing of the files to be completed. Other applications are now free to read the files (but not execute them).
S37. After the queue is full, or after a fixed time interval, the antivirus application 4 scans the files in the queue (or sends them to a backend server for analysis). This may occur in a “batch mode”, where several logical queries are joined in a single network lookup. The files are found to be unknown, and the icons for the files are changed.
S38. The user executes application.exe
S39. The antivirus application 4 is aware that application.exe is unknown, and the TTL has not expired, and so execution of application.exe is allowed.
S40. Application.exe loads library1.dll and library2.dll
S41. The antivirus sees both files are unknown, and the TTL has not expired. Load is allowed.
S42. Application is allowed to execute with the dll libraries.
S43. As the TTLs for the unknown files expire, the files are again placed in the background scanning queue and put into “cloud quarantine” until the state is refreshed.

By changing (or hiding) an icon associated with a file when it has been placed in cloud quarantine state, the user is alerted to the fact that the file has been written to disk, but not yet processed by the anti-virus application. For those executable files, the state is visualized by changing the user-visible icon with a legend such as an hourglass or something similar. The same visualization can be used to inform the user about files that are found to be “known-clean”, for example by using an icon with a green checkmark.

The same process may be used when the product is in an offline state. However, in this case the product may either block the execution of quarantined files altogether, or request the user to explicitly allow such applications to be launched.

Alerting the user to the current scanning status of an electronic file in cloud quarantine has several advantages. If the electronic file in cloud quarantine turns out to be malware, the alert may become as a surprise to a user since she may have downloaded the file significantly earlier. However, by making the user aware of the current state of analysis using an icon associated with the file, the user remains aware of the current state of analysis and knows that the electronic file is yet to be processed. Furthermore, the operation of the antivirus application 4 is made visible to the user. The user sees, in a subtle and non-intrusive way, that the antivirus application 4 is protecting the computer system 1 and perceives that the anti-virus application 4 is working.

It will be appreciated by the person of skill in the art that various modifications may be made to the above described embodiment without departing from the scope of the present invention.

1. A method of performing an anti-virus scan on an electronic file, the method comprising:
using an anti-virus application running at a computer device, determining that an electronic file requires scanning;
placing the electronic file in a queue for analysis, and altering the state of the electronic file such that the electronic file can be written to a memory but not accessed before analysis is complete;
altering an icon associated with the electronic file to indicate that analysis of the electronic file is not complete, the icon being displayable on a display device; and
once the electronic file has been analysed, altering the icon associated with the electronic file to indicate that it has been analysed.

2. The method according to claim 1, wherein prior to completion of analysis of the electronic file, the icon associated with the electronic file is further altered to indicate an altered sub-state within the analysis procedure.

3. The method according to claim 1, wherein the icon is altered to indicate that the analysis of the electronic file is not complete by suppressing display of the icon associated with the electronic file.

4. The method according to claim 1, wherein the icon is altered to indicate that analysis of the electronic file is not complete by setting an attribute of the electronic file to hidden.

5. The method according to claim 1, wherein in the event that an attempt is made to access the electronic file prior to completion of the analysis, a position of the electronic file in the queue is changed such that the electronic file is analyzed after a current analysis of a further electronic file is complete, and the electronic file is analysed prior to allowing accessing of the electronic file.

6. The method according to claim 1, wherein in the event that an attempt is made to access the electronic file prior to completion of the analysis, a current analysis operation on a further electronic file is suspended, and the electronic file is analysed prior to allowing accessing of the electronic file.

7. The method according to claim 1, wherein in the event that an attempt is made to access the electronic file prior to completion of the analysis, the user is prompted via the display device to determine whether or not to allow access to the electronic file.

8. The method according to claim 1, wherein the anti-virus application sends a network query to a remote anti-virus server during the analysis process.

9. The method according to claim 1, wherein the anti-virus application sends a single message comprising information relating to a plurality of files to a remote anti-virus server during the analysis process.

10. The method according to claim 1, wherein in the event that the anti-virus application normally sends a network query to a remote anti-virus server during the analysis process, and a network connection to the remote anti-virus server is unavailable, and it is required to execute the electronic file, the user is prompted via the display device to determine whether or not to allow execution of the electronic file.

11. The method according to claim 1, wherein in the event that the anti-virus application normally sends a network query to a remote anti-virus server during the analysis process, and a network connection to the remote anti-virus server is unavailable, and it is required to execute the electronic file, the user is prompted via the display device to determine whether or not to disable the anti-virus application.

12. The method according to claim 1, wherein once the electronic file has been analysed, the icon associated with the electronic file is altered to one of the icon normally associated with the electronic file, an icon indicating that the file has been analysed and does not comprise malware, an icon indicating that the file has been analysed and does comprise malware, and an icon indicating that the file has been analysed and it is not known whether it comprises malware.

13. The method according to claim 1, wherein it is determined that an electronic file requires analysis prior to writing the electronic file to the memory.

14. The method according to claim 1, wherein it is determined that an electronic file requires analysis in the event that a time-to-live setting associated with the electronic file has expired.

15. The method according to claim 1, wherein access to the electronic file comprises any of execution of the electronic file by an operating system, interpretation of the electronic file by an interpreter, attachment of the electronic file to a message, sending the electronic file to a remote node via a communications network, copying the electronic file to an external memory, and displaying information obtained from the electronic file by a data file viewing application.

16. A computer device comprising:
a memory for storing a plurality of electronic files;
a processor for running an anti-virus application, wherein the anti-virus application is arranged to determine that an electronic file requires analysis;
the processor being further arranged to place the electronic file in a queue for analysis, and allow the electronic file to be written to the memory but not accessed before analysis is complete;
wherein the processor is further arranged to alter an icon associated with the electronic file to indicate that analysis of the electronic file is not complete;
a display for displaying the icon to a user; and
wherein the processor is arranged to submit the electronic file for analysis and, once the electronic file has been analysed, the processor is further arranged to alter the icon associated with the electronic file to indicate that it has been analysed.

17. The computer device according to claim 16, wherein the processor is arranged to, prior to the completion of analysis of the electronic file, further alter the icon associated with the electronic file to indicate an altered sub-state within the analysis procedure.

18. The computer device according to claim 16, wherein the processor is arranged to alter the icon by suppressing display of the icon associated with the electronic file.

19. The computer device according to claim 16, wherein the processor is arranged to, in the event that the anti-virus application normally sends a network query to a remote anti-virus server during the analysis process, and a network connection to the remote anti-virus server is unavailable, and it is required to execute the electronic file, prompt the user via the display device to determine whether or not to allow execution of the electronic file.

20. The computer device according to claim 16, wherein the processor is arranged determined that an electronic file requires analysis either prior to writing the electronic file to the memory or in the event that a time-to-live setting associated with the electronic file has expired.

21. A computer program, comprising computer readable code which, when run on a computer device, causes the computer device to perform the method as claimed in claim 1.

22. A computer program product comprising a computer readable medium and a computer program according to claim 21, wherein the computer program is stored on the computer readable medium.
